(19) United States
(12) Patent Application Publication
(10) Pub. No.: US 2014/0298064 A1
(43) Pub. Date: Oct. 2, 2014

(54) ELECTRONIC SYSTEM WITH AUTO POWER-OFF FUNCTION AND OPERATING METHOD THEREOF

(71) Applicant: Chia-Hsiu LIN, Hsinchu City (TW)

(72) Inventor: Chia-Hsiu LIN, Hsinchu City (TW)

(21) Appl. No.: 14/229,031

(22) Filed: Mar. 28, 2014

(30) Foreign Application Priority Data
Mar. 29, 2013 (TW) 102111487

(51) Int. Cl. G06F 1/32

(52) U.S. Cl. CPC G06F 1/3231
USPC 713/323

(57) ABSTRACT

An electronic system with auto power-off function including a power source, an electronic device, a detection unit, and a processing unit is disclosed. The power source is used to provide the power need to operate the electronic system. The detection unit is used to detect a plurality of raw data on the electronic device. The processing unit is coupled to the detection unit and the power and used to determine whether a raw data changing region on the electronic device is larger than a threshold area according to the plurality of raw data and to selectively shut down the power source.

### BACKGROUND OF THE INVENTION

1. Field of the Invention

This invention relates to electronic apparatus, especially to an electronic system with auto power-off function and an operating method thereof.

2. Description of the Prior Art

With the development of technology, the electronic apparatus can provide various kinds of functions, such as water-proof function or dust-proof function. These functions are quite practical for consumers. There are many detailed definition and specification for the water-proof function in the world. For example, in IEC-60529 standard of International Electro-technical Commission (TEC), levels of Ingress Protection (IP) are defined. The highest level IP-67 of product can bear a lot of dust (dust-proof level is 6) and not damaged in 1 m-deep water (water-proof level is 7).

However, in general, few consumer mobile devices can meet this highest level, and the IP levels are not widely used in the specification of capacitive touch monitor. Even some smart phone are designed with water-proof and dust-proof function of IP55/IP57 level, they are too expensive for ordinary consumer to buy.

Therefore, the invention provides an electronic system with auto power-off function and an operating method thereof to solve the above-mentioned problems.

### SUMMARY OF THE INVENTION

A scope of the invention is to provide an electronic, system with auto power-off function. An embodiment of the invention is an electronic system with auto power-off function. In this embodiment, the electronic system with auto power-off function includes a power source, an electronic device, a detection unit, and a processing unit. The power source is used to provide the power need to operate the electronic system. The detection unit is used to detect a plurality of raw data on the electronic device. The processing unit is coupled to the detection unit and the power. The processing unit is used to determine whether a raw data changing region on the electronic device is larger than a threshold area according to the plurality of raw data and to selectively shut down the power source.

In an embodiment, the electronic device is a touch panel having a plurality of electrodes arranged in a matrix.

In an embodiment, if the processing unit determines that the raw data changing region on the electronic device is larger than the threshold area, the processing unit will generate a shut-down signal to the power source to shut down the power source.

In an embodiment, the threshold area is larger than a touch area of a normal finger.

In an embodiment, the detection unit further detects a physical parameter of the raw data changing region on the electronic device, and the physical parameter is temperature, resistance, capacitance, optical refractive index, optical reflectivity, or permeability.

In an embodiment, if the processing unit determines that the raw data changing region on the electronic device is larger than the threshold area, the processing unit will further determine whether the physical parameter of the raw data changing region is in a range of a default value; if no, the processing unit will generate a shut-down signal to the power source to shut down the power source.

In an embodiment, the default value comprises normal human body temperature, resistance, capacitance, optical refractive index, optical reflectivity, or permeability.

In an embodiment, the plurality of raw data is a value or a code varied with different touch behaviors acted on the electronic device.

Another scope of the invention is to provide an electronic system operating method. Another embodiment of the invention is an electronic system operating method used for operating an electronic system with auto power-off function. The electronic system includes a power source, an electronic device, a detection unit, and a processing unit. The electronic system operating method includes steps of: (a) the detection unit detecting a plurality of raw data on the electronic device; (b) the processing unit determining whether a raw data changing region on the electronic device is larger than a threshold area according to the plurality of raw data; and (c) the processing unit selectively shutting down the power source according to the determined result of the step (b).

Compared to the prior art, the electronic system with auto power-off function of the invention determines whether the raw data changing region on the electronic device is larger than the threshold area by detecting the plurality of raw data on the electronic device, when the electronic device is splashed or wet by water or other liquids, the electronic system will shut down the power source to protect the electronic system.

In addition, the electronic system will detect the physical parameter (for example, temperature, resistance, capacitance, optical refractive index, optical reflectivity, or permeability) of the raw data changing region on the electronic device to ensure that it is water or other liquids, not a palm, contacting the electronic device. Therefore, the situation that the power source is shut down by mistake when the palm touches the electronic devices can be avoided.

Moreover, the electronic system of the invention can be applied in cell phone, tablet PC, notebook PC, and even wearable electronic device, and the detection unit of the electronic system can be individually designed and cover all region needing auto power-off protection, or it can be realized by modifying firmware.

The advantage and spirit of the invention may be understood by the following detailed descriptions together with the appended drawings.

### BRIEF DESCRIPTION OF THE APPENDED DRAWINGS

FIG. 1 illustrates a schematic diagram of a control circuit and a power source applied in the electronic device.

FIGS. 2A and 2B illustrate schematic diagrams of the electronic system with auto power-off function in an embodiment of this invention.

FIG. 3A illustrates a schematic diagram of the raw data changing region on the electronic device smaller than the threshold area.

FIG. 3B illustrates a schematic diagram of the raw data changing region on the electronic device larger than the threshold area.

FIG. 4 illustrates a flowchart of the electronic system operating method in an embodiment of this invention.

FIG. 5 illustrates flowchart of the electronic system operating method in another embodiment of this invention.

### DETAILED DESCRIPTION OF THE INVENTION

A preferred embodiment of the invention is an electronic system with auto power-off function. In this embodiment, the electronic system with auto power-off function in the invention can be applied in cell phone, tablet PC, notebook PC, or even wearable electronic device. When the region needed to be protected (for example, touch panel or button) on the electronic device (for example, cell phone or tablet PC) is splashed or wet by water or other liquids, the electronic system will shut down the power source to protect the electronic system from being damaged, and the situation that the power source is shut down by mistake when the palm touches the electronic devices can be also avoided.

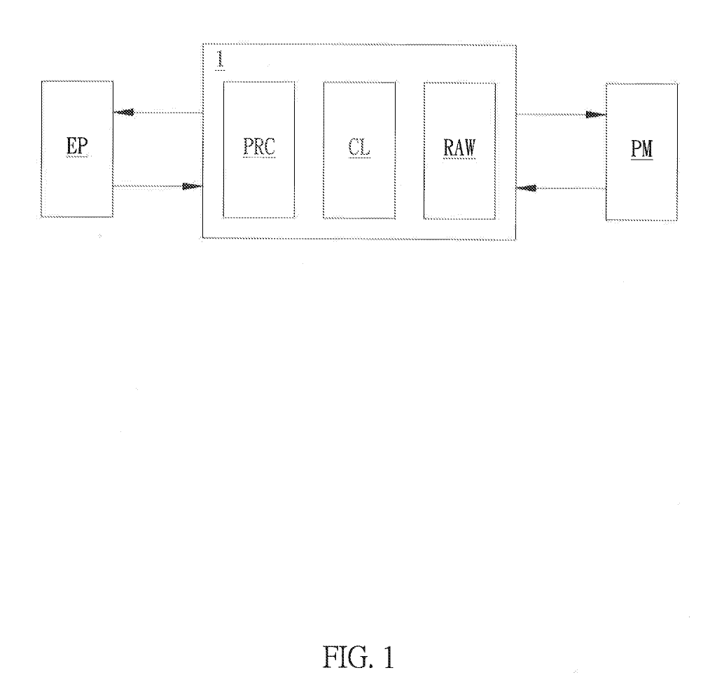

At first, please refer to FIG. 1. FIG. 1 shows an embodiment of a control circuit and a power source applied in an electronic device. As shown in FIG. 1, the control circuit 1 is coupled between a power source PM and an electronic apparatus EP. In this embodiment, the control circuit 1 can include a processor PRC, a raw data detection unit RAW, a control logic circuit CL, and other units.

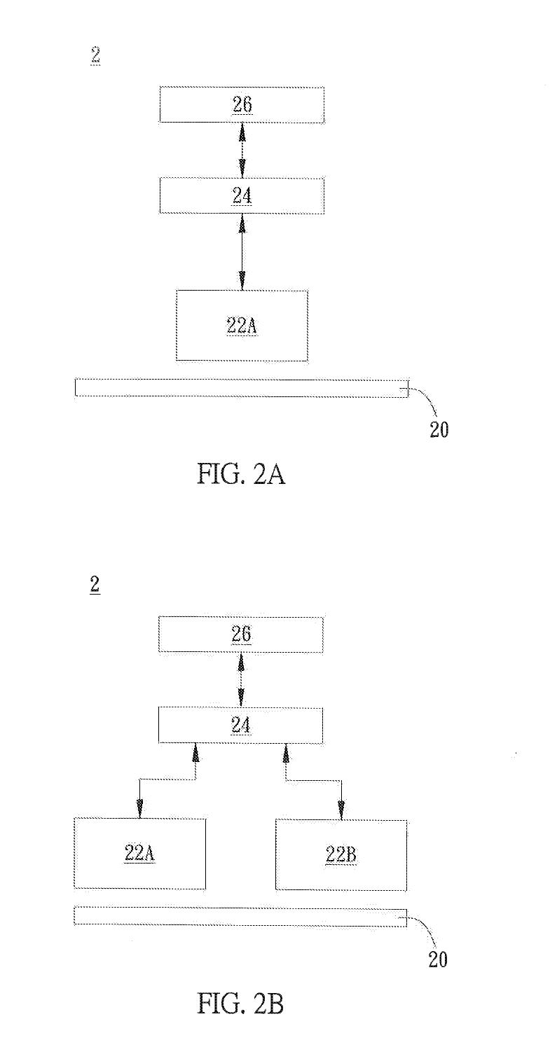

Please refer to FIG. 2A. FIG. 2A shows a schematic diagram of the electronic system with auto power-off function. As shown in FIG. 2A, the electronic system 2 includes an electronic device 20, a first detection unit 22A, a processing unit 24, and a power source 26. Wherein, the first detection unit 22A is coupled to the processing unit 24; the processing unit 24 is coupled to the power source 26. In addition, in order to provide more accurate detection result, the electronic system of the invention can further include other detection units. For example, the electronic system 2 of FIG. 2B further includes a second detection unit 22B coupled to the processing unit 24, but not limited to this.

The electronic device 20 can be a cell phone, a tablet PC, a notebook PC, a wearable electronic device, or other electronic device without any limitations. In an embodiment, the electronic device 20 includes a touch panel, such as a capacitive touch panel or a resistive touch panel. A plurality of sensing lines and a plurality of driving lines can be disposed on the touch panel, and the plurality of sensing lines and the plurality of driving lines are vertically aligned with each other. In addition, the electronic device 20 can also include at least one button, such as the button on the cell phone.

The power source 26 is used to provide power for the units of the electronic system 2 to operate. The first detection unit 22A is used to detect a plurality of raw data on the electronic device 20 and transmit the plurality of raw data to the processing unit 24. In fact, the first detection unit 22A performs detection on the region needed to be protected (for example, touch panel or button) on the electronic device 20 to obtain the plurality of raw data related to the region needed to be protected on the electronic device 20.

It should be noticed that the plurality of raw data can be value or code, for example, values from 0 to 255 or codes from AA to ZZ, but not limited to this. In fact, the plurality of raw data will be varied with different touch behaviors of the user. For example, the value of the raw data is changed from 50 to 200, or the code of the raw data is changed from CF to MX, but not limited to this. In addition, the first detection unit 22A can be individually designed and cover all region needing auto power-off protection on the electronic device 20, or it can be realized by modifying firmware.

When the processing unit 24 receives the plurality of raw data, the processing unit 24 will determine whether a raw data changing region on the electronic device 20 is larger than a threshold area according to the plurality of raw data. In practical applications, the threshold area is larger than a touch area of a normal finger, but not limited to this.

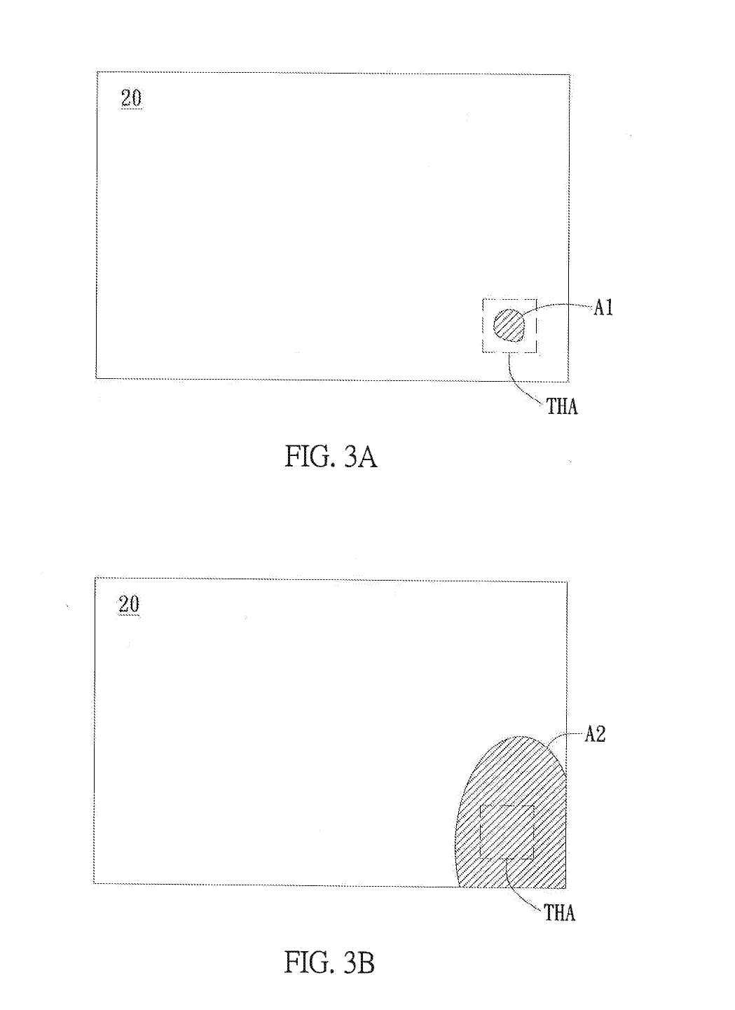

For example, as shown in FIG. 3A, it is assumed that the raw data changing region on the electronic device 20 is A1 and the threshold area is THA. Obviously, because the raw data changing region A1 is not larger than the threshold area THA, the processing unit 24 will determine that the raw data changing region A1 on the electronic device 20 is not larger than the threshold area THA; that is to say, the processing unit 24 determines that the raw data changes in the raw data changing region A1 on the electronic device 20 are caused when the electronic device 20 is touched by the finger of the user. Since these raw data changes in the raw data changing region A1 on the electronic device 20 are not caused by water or other liquids, the power source 26 will continuously provide power to the electronic system 2 to maintain the normal operation of the electronic system 2.

However, as shown in FIG. 3B, if the raw data changing region on the electronic device 20 is A2 and the threshold area is THA. Obviously, because the raw data changing region A2 is larger than the threshold area THA, the processing unit 24 will determine that the raw data changing region A2 on the electronic device 20 is larger than the threshold area THA; that is to say, the processing unit 24 determines that the raw data changes in the raw data changing region A2 on the electronic device 20 are caused by water or other liquids. Since these raw data changes in the raw data changing region A2 on the electronic device 20 are not caused when the electronic device 20 is touched by the finger of the user, the power source 26 will generate a shut-down signal to the power source 26 to shut down the power source 26 to protect the electronic system from being damaged by water or other liquids.

Except the above-mentioned operation modes, the electronic system 2 still has other physical parameter detection mechanism to avoid the situation that the electronic system 2 shuts down the power source 26 by mistake because the palm of the user carelessly touches the electronic device 20. For example, the first detection unit 22A can further detect the physical parameter of the raw data changing region A2. In fact, the physical parameter can be temperature, resistance, capacitance, optical refractive index, optical reflectivity, or permeability

If the physical parameter is temperature, for example, as shown in FIG. 2 and FIG. 3B, when the raw data changing region A2 is larger than the threshold area THA, the processing unit 24 will further determine whether the temperature of the raw data changing region A2 on the electronic system 2 detected by the first detection unit 22A is in a specific temperature range.

In practical applications, the above-mentioned specific temperature range can cover normal human body temperature range. For example, the specific temperature range can be set between 32° C. and 42° C. to effectively exclude the situation that the palm of the user carelessly touches the electronic device 20.

If the temperature of the raw data changing region A2 on the electronic system 2 detected by the first detection unit 22A is 36° C., the processing unit 24 will determine that the temperature is in the specific temperature range (between 32° C. and 42° C.) and the situation of FIG. 3B may be caused because the palm of the user carelessly touches the electronic device 20. Therefore, the power source 26 will continuously provide power to the electronic system 2 to maintain normal operation of the electronic system 2.

If the temperature of the raw data changing region A2 on the electronic system 2 detected by the first detection unit 22A is 20° C., the processing unit 24 will determine that the temperature is not in the specific temperature range (between 32° C. and 42° C.) and the situation of FIG. 3B may be caused by water or other liquids on the electronic device 20. Therefore, the power source 26 will generate a shut-down signal to the power source 26 to shut down the power source 26 to protect the electronic system 2 from being damaged by water or other liquids.

If the physical parameter is resistance, for example, as shown in FIG. 2 and FIG. 3B, when the raw data changing region A2 is larger than the threshold area THA, the processing unit 24 will further determine whether the resistance of the raw data changing region A2 on the electronic system 2 detected by the first detection unit 22A is in a default resistance range.

It is assumed that the default resistance range can cover normal human body range. If the resistance of the raw data changing region A2 on the electronic system 2 detected by the first detection unit 22A is in the default resistance range, the situation of FIG. 3B may be caused because the palm of the user carelessly touches the electronic device 20. Therefore, the power source 26 will continuously provide power to the electronic system 2 to maintain normal operation of the electronic system 2.

If the resistance of the raw data changing region A2 on the electronic system 2 detected by the first detection unit 22A is not in the default resistance range, the situation of FIG. 3B may be caused by water or other liquids on the electronic device 20. Therefore, the power source 26 will generate a shut-dawn signal to the power source 26 to shut down the power source 26 to protect the electronic system 2 from being damaged by water or other liquids.

If the physical parameter is optical reflectivity, for example, as shown in FIG. 2 and FIG. 3B, when the raw data changing region A2 is larger than the threshold area THA, the processing unit 24 will further determine whether the optical reflectivity of the raw data changing region A2 on the electronic system 2 detected by the first detection unit 22A is in a default optical reflectivity range. In fact, the first detection unit 22A can detect the optical reflectivity by emitting an incident light to the raw data changing region A2 on the electronic device 20 and receiving a reflected light from the object on the raw data changing region A2.

It is assumed that the default optical reflectivity range can cover the optical reflectivity range of the reflected light reflected by human body. If the optical reflectivity of the raw data changing region A2 on the electronic system 2 detected by the first detection unit 22A is in the default optical reflectivity range, the situation of FIG. 3B may be caused because the palm of the user carelessly touches the electronic device 20. Therefore, the power source 26 will continuously provide power to the electronic system 2 to maintain normal operation of the electronic system 2.

If the optical reflectivity of the raw data changing region A2 on the electronic system 2 detected by the first detection unit 22A is not in the default resistance range, the situation of FIG. 3B may be caused by water or other liquids on the electronic device 20. Therefore, the power source 26 will generate a shut-down signal to the power source 26 to shut down the power source 26 to protect the electronic system 2 from being damaged by water or other liquids.

As to the situation that the physical parameter is capacitance, optical refractive index, or permeability, it is similar to the above-mentioned cases and not described again here.

As shown in FIG. 2B, if the electronic system 2 includes the first detection unit 22A and the second detection unit 22B, the first detection unit 22A and the second detection unit 22B can detect different physical parameters. For example, if the first detection unit 22A detects temperature and the second detection unit 22B detects optical reflectivity, when the raw data changing region A2 is larger than the threshold area THA, the processing unit 24 will further determine whether the temperature of the raw data changing region A2 on the electronic system 2 detected by the first detection unit 22A is in a specific temperature range and determine whether the optical reflectivity of the raw data changing region A2 on the electronic system 2 detected by the second detection unit 22B is in a default optical reflectivity range. If the above-mentioned two determined results performed by the processing unit 24 are no, that is to say, the temperature of the raw data changing region A2 on the electronic system 2 detected by the first detection unit 22A is not in the specific temperature range and the optical reflectivity of the raw data changing region A2 on the electronic system 2 detected by the second detection unit 22B is not in the default optical reflectivity range. Therefore, the situation of FIG. 3B may be caused by water or other liquids on the electronic device 20. The power source 26 will generate a shut-down signal to the power source 26 to shut down the power source 26 to protect the electronic system 2 from being damaged by water or other liquids.

Another embodiment of the invention is an electronic system operating method used for operating an electronic system with auto power-off function. The electronic system includes a power source, an electronic device, a detection unit, and a processing unit.

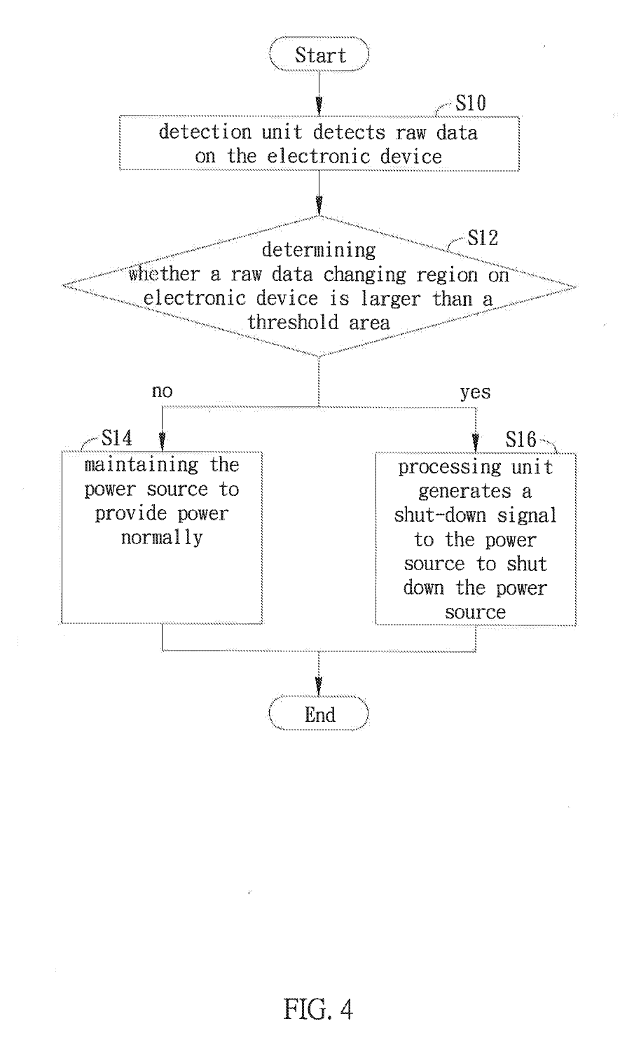

Please refer to FIG. 4, FIG. 4 illustrates a flowchart of the electronic system operating method in an embodiment of this invention. As shown in FIG. 4, in the step S10, the detection unit detects a plurality of raw data on the electronic device. In the step S12, the processing unit determines whether a raw data changing region on the electronic device is larger than a threshold area according to the plurality of raw data. If the determined result of the step S12 is no, the method performs the step S14 to maintain the power source to provide power normally. If the determined result of the step S12 is yes, the method performs the step S16, the processing unit generates a shut-down signal to the power source to shut down the power source.

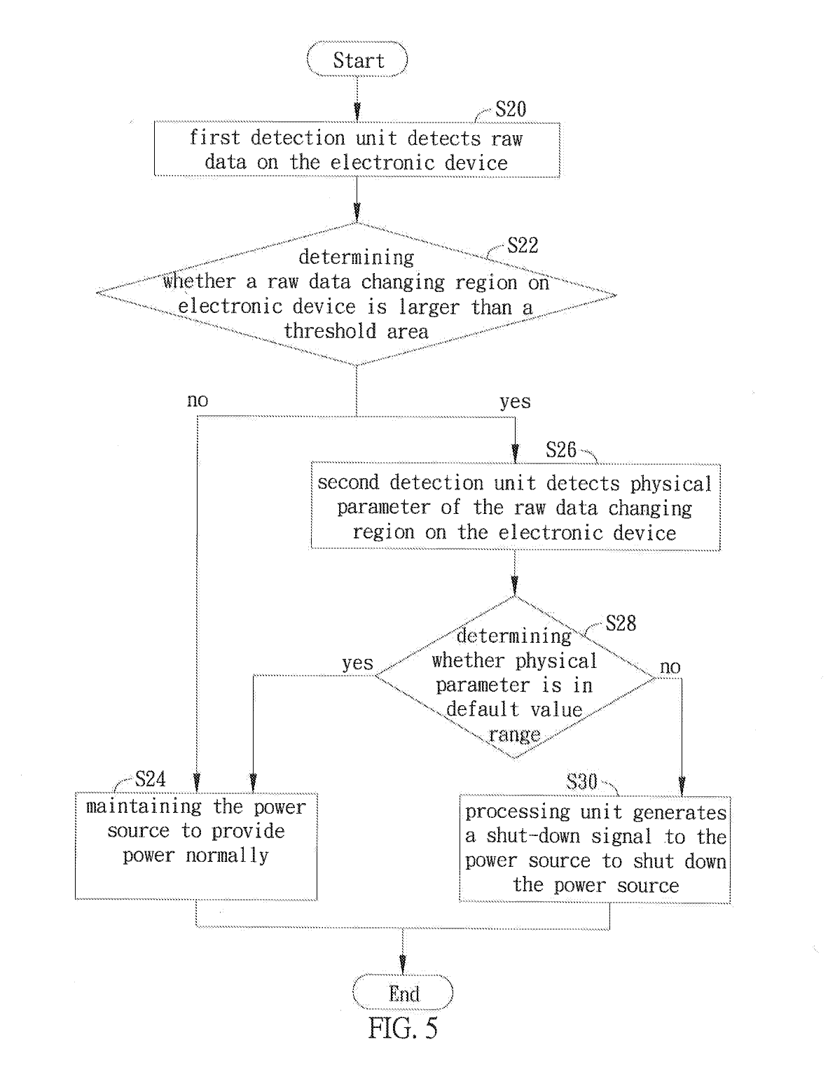

In another embodiment, the electronic system includes a power source, an electronic device, a first detection unit, a second detection unit, and a processing unit. Please refer to FIG. 5. FIG. 5 illustrates a flowchart of the electronic system operating method in an embodiment of this invention. As shown in FIG. 5, in the step S20, the first detection unit detects a plurality of raw data on the electronic device. In the step S22, the processing unit determines whether a raw data changing region on the electronic device is larger than a threshold area according to the plurality of raw data. If the determined result of the step S22 is no, the method performs the step S24 to maintain the power source to provide power normally. If the determined result of the step S22 is yes, the method performs the step S26 that the second detection unit detects physical parameter of the raw data changing region on the electronic device.

Then, in the step S28, the processing unit determines whether the physical parameter of the raw data changing region is in a range of a default value. In fact, the physical parameter can be temperature, resistance, capacitance, optical refractive index, optical reflectivity, or permeability. If the determined result of the step S28 is yes, the method performs the step S24 to maintain the power source to provide power normally. If the determined result of the step S28 is no, the method performs the step S30, the processing unit generates a shut-down signal to the power source to shut down the power source.

In practical applications, the first detection unit and the second detection unit of the electronic system can detect different physical parameters. For example, if the first detection unit detects temperature and the second detection unit detects optical reflectivity, when the raw data changing region is larger than the threshold area, the processing unit will further determine whether the temperature of the raw data changing region on the electronic system detected by the first detection unit is in a specific temperature range and determine whether the optical reflectivity of the raw data changing region on the electronic system detected by the second detection unit is in a default optical reflectivity range.

If the above-mentioned two determined results performed by the processing unit are no, that is to say, the temperature of the raw data changing region on the electronic system detected by the first detection unit is not in the specific temperature range and the optical reflectivity of the raw data changing region on the electronic system detected by the second detection unit is not in the default optical reflectivity range. The power source will generate a shut-down signal to the power source to shut down the power source to protect the electronic system from being damaged by water or other liquids.

Compared to the prior art, the electronic system with auto power-off function of the invention determines whether the raw data changing region on the electronic, device is larger than the threshold area by detecting the plurality of raw data on the electronic device, when the electronic device is splashed or wet by water or other liquids, the electronic system will shut down the power source to protect the electronic system.

In addition, the electronic system will detect the physical parameter (for example, temperature, resistance, capacitance, optical refractive index, optical reflectivity, or permeability) of the raw data changing region on the electronic device to ensure that it is water or other liquids, not a palm, contacting the electronic device. Therefore, the situation that the power source is shut down by mistake when the palm touches the electronic devices can be avoided.

Moreover, the electronic system of the invention can be applied in cell phone, tablet PC, notebook PC, and even wearable electronic device, and the detection unit of the electronic system can be individually designed and cover all region needing auto power-off protection, or it can be realized by modifying firmware.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and hounds of the appended claims.

What is claimed is:

1. An electronic system with auto power-off function, comprising:
a power source, for providing power need to operate the electronic system;
an electronic device;
a detection unit, for detect a plurality of raw data on the electronic device; and
a processing unit, coupled to the detection unit and the power source, for determining whether a raw data changing region on the electronic device is larger than a threshold area according to the plurality of raw data and selectively shutting down the power source.

2. The electronic system of claim 1, wherein the electronic device is a touch panel having a plurality of electrodes arranged in a matrix.

3. The electronic system of claim 1, wherein if the processing unit determines that the raw data changing region on the electronic device is larger than the threshold area, the processing unit generates a shut-down signal to the power source to shut down the power source.

4. The electronic system of claim 1, wherein the threshold area is larger than a touch area of a normal finger.

5. The electronic system of claim 1, wherein the detection unit further detects a physical parameter of the raw data changing region on the electronic device, and the physical parameter is temperature, resistance, capacitance, optical refractive index, optical reflectivity, or permeability.

6. The electronic system of claim 5, wherein if the processing unit determines that the raw data changing region on the electronic device is larger than the threshold area, the processing unit further determines whether the physical parameter of the raw data changing region is in a range of a default value, if no, the processing unit generates a shut-down signal to the power source to shut down the power source.

7. The electronic system of claim 6, wherein the default value comprises normal human body temperature, resistance, capacitance, optical refractive index, optical reflectivity, or permeability.

8. The electronic system of claim 5, wherein the plurality of raw data is a value or a code varied with different touch behaviors acted on the electronic device.

9. An electronic system operating method, for operating an electronic system with auto power-off function, the electronic system comprising a power source, an electronic device, a detection unit, and a processing unit, the electronic system operating method comprising steps of:
(a) the detection unit detecting a plurality of raw data on the electronic device;
(b) the processing unit determining whether a raw data changing region on the electronic device is larger than a threshold area according to the plurality of raw data; and
(c) the processing unit selectively shutting down the power source according to the determined result of the step (b).

10. The electronic system operating method of claim 9, wherein if the determined result of the step (b) is yes, the processing unit generates a shut-down signal to the power source to shut down the power source.

11. The electronic system operating method of claim 9, wherein the threshold area is larger than a touch area of a normal finger.

12. The electronic system operating method of claim 9, further comprising a step of:
the detection unit further detecting a physical parameter of the raw data changing region on the electronic device, wherein the physical parameter is temperature, resistance, capacitance, optical refractive index, optical reflectivity, or permeability.

13. The electronic system operating method of claim 12, wherein if the determined result of the step (b) is yes, the electronic system operating method further comprises steps of:
the processing unit determining whether the physical parameter of the raw data changing region is in a range of a default value; and
if no, the processing unit generating a shut-down signal to the power source to shut down the power source.

14. The electronic system operating method of claim 13, wherein the default value comprises normal human body temperature, resistance, capacitance, optical refractive index, optical reflectivity, or permeability.

15. The electronic system operating method of claim 9, wherein the plurality of raw data is a value or a code varied with different touch behaviors acted on the electronic device.
